(19) United States
(12) Patent Application Publication
(10) Pub. No.: US 2026/0249818 A1
(43) Pub. Date: Aug. 27, 2026

(54) Tire Pressure Control with AV Notification and Alarm

(71) Applicant: Harold St. Felix, Greenacres, FL (US)

(72) Inventor: Harold St. Felix, Greenacres, FL (US)

(21) Appl. No.: 19/393,385

(22) Filed: Nov. 18, 2025

Related U.S. Application Data
(60) Provisional application No. 63/761,355, filed on Feb. 21, 2025.

(51) Int. Cl. B60S 5/04; G01L 17/00

(52) U.S. Cl. CPC B60S 5/046; G01L 17/00

(57) ABSTRACT

The tire pressure control with visual feedback notifications includes a proximity sensor, operative with a tire pressure supply hose. A sensory and feedback unit (SFU) is removably attached intermediate the tire stem and the supply hose stem pneumatic coupler. The SFU has a first pneumatic coupler adapted to be removably attached to the vehicle tire stem. When attached, inflation air is supplied through an SFU pneumatic passage. A controller reads pressure PS via a sensor on the passage and determines, in some cases, over-pressure, under-pressure and recommended tire pressure PRI. When PS equal PRI, controller enables illumination of one or more lights on the SFU. A user interface (UI) sets the PRI in the controller memory. Power is a replaceable battery, a rechargeable battery and the SFU may have a kinetic generator for power.

This is a non-provisional patent application based upon and claiming the benefit of provisional patent application Ser. No. 63/761,355 filed on Feb. 21, 2025, the contents of which is incorporated herein by reference thereto. The present invention relates to a tire pressure inflation sensor and control system with visual user feedback and audible feedback subsystems.

### BACKGROUND

There are several different tire pressure inflation systems. When the inflation air supply line is coupled to the tire stem (this stem having an internal valve which opens when the supply line port engages the vehicle tire stem), the internal time pressure matches the air-supplied pressure. There are many tire inflation systems controlled by tire pressure signals monitoring the pressure in the coupled pneumatic lines. USPN 9,773,356 discloses an air dispensary system, a transponder on the vehicle, and a data-processing system at the dispensary. The vehicle-mounted transponder receives, from the vehicle, a wireless command transmission (“transmit”) and supplies to the air dispensary system and data processing system information identifying the make and model of the car and the fact that the front tire is mounted on the front axle. Suitable wireless identifiers include near-field communication (“NFC”) chips or RFID chips. Other examples of wireless identifiers are Bluetooth enabled or that communicate via a WiFi network. In an RFIS system, the transponder is an RFID chip which is activated by an RFID reader in the air dispensary system. USPN 9,773,356 also discloses a controller coupled to a data system which matches the vehicle type to the appropriate tire pressure.

U.S. Patent publication no. 20080266073 discloses that some type of sensory system inside the tire that sends a signal to a controller in the air dispensary system. The controller, outside of the automobile and remote from the automobile, controls air pressure and air supplied to the tire via the tire stem. The controller has a database which stores the recommended tire pressure for the vehicle or automobile.

USPN 11,571,936 discloses a customized valve stem operative with a system in a tire rim which further includes an inflator box. The inflator box as a counter weight held against an outer circumferential surface of the tire rim by a wrap. The wrap holds the counter weight and the inflator box in positions opposite one another. The inflator box is coupled to an atmospheric channel in a valve stem by an atmospheric hose. An electric air pump is located inside of the inflator box which pump draws air through the atmospheric hose and valve stem and out of the short hose into an interior air cavity of the tire. The valve stem is a custom valve stem that can replace a conventional OEM valve stem and can be installed as an aftermarket improvement along with the inflator box. The inflator box has its own pressure monitor and can co-exist separately from an original equipment manufacturer tire pressure monitoring system (TPMS).

USPN 10,576,941 discloses a tire and a tire valve configured to receive air from, e.g., an air compressor pneumatic pump station. The pneumatic pump in the station pushes pressurized air through the supply hose and through a nozzle which is attached to the tire valve. The nozzle is configured to release air from the tires if, e.g., the tire pressure is higher than the recommended or target pressure. Thus, the nozzle includes a pressure release valve that is controlled by the pump system station. Other prior art systems controlling inflation air flow are disclosed in USPN 606,785 and USPN 12,187,244.

Also, there are tire lighting systems which can be threaded onto the common tire stem (the common tire stem having an internal tire pressure valve). These tire lights are battery supplied and are motion activated with the tire rims are rotating. See, for example, BloomCare ™ TyreGlow™ lights.

### SUMMARY

The present invention relates to a tire pressure inflation sensor and control system with visual user feedback and audible feedback subsystems. The invention overcomes the aforementioned disadvantages in prior art devices.

With the foregoing and other objects in view, there is provided, in accordance with the invention, a tire pressure inflation sensor and control system with a visual user feedback adapted to be actuated by a proximity element at a terminal end of a tire pressure hose. The tire pressure hose is adapted to deliver inflation air under pressure to a vehicle tire via a hose stem pneumatic coupler at the terminal end of the tire pressure hose during a tire inflation cycle. The hose stem coupler is removable, but is attached to a vehicle tire stem during an inflation cycle.

The tire pressure inflation sensor and control system includes a sensory and feedback unit (SFU) adapted to be removably attached intermediate the vehicle tire stem and the hose stem coupler. The SFU has a first pneumatic coupler adapted to be removably attached to the vehicle tire stem and a second pneumatic coupler adapted to be removably attached to the hose stem pneumatic coupler. The SFU has a pneumatic passage therethrough interconnecting the first and second pneumatic couplers. A proximity reader in the SFU generates a proximity signal (PX) when the reader is within range of the proximity element of the tire pressure hose. A pressure sensor in the pneumatic passage generates an inflation air pressure signal (PS) during tire inflation. The SFU has a plurality of lights enabled to provide the visual user feedback. The SFU has a controller coupled to the pressure sensor which receive the PS signal. The controller is also coupled to the proximity reader and receives the PX signal. The controller's memory stores a predetermined recommended tire inflation (PRI) value for the vehicle tire. When the controller matches the PRI value with the Ps signal within a banded +/−range, the controller enables illumination of one or more lights providing a positive visual user feedback.

Another embodiment includes a user actuatable (UI) interface on the SFU which is coupled to the controller. The UI interface is disposed on an exterior surface of the SFU. The user is enabled to enter the PRI value into the memory store. When the controller does not match the PRI value with the PS signal, the controller enables illumination of at least a second light of the plurality of lights as a negative visual user feedback.

A further embodiment of the invention includes a battery disposed or located in the SFU. The battery powers the controller, the pressure sensor and the proximity reader.

Another embodiment of the invention includes a rechargeable battery recharged by at least one type of recharging power source. These recharging power sources may be (a) an onboard kinetic energy conversion (KE) module disposed or located in the SFU; (b) an interconnected power line from a powered tire pressure supply hose (the powered tire pressure hose including an electrical power supply line and a hose e-coupler port, and the SFU having an e-coupler port to electrically connect to the hose e-coupler port); and (c) a recharge power line removably coupled to an external recharging station port.

Further embodiments of the present invention provide that the proximity element and the proximity reader are either (a) a RFID tag and a RFID reader; or (b) a near field communication (NFC) tag and a NFC reader.

Other embodiments of the present invention use a plurality of lights which includes three or more lights (herein “3+lights”). At least a first subset or light group of the 3+ lights represents, when lit by the controller during an operational phase, positive visual user feedback. A second subset or light group of the 3+ lights represents, when lit, negative visual user feedback. When the controller matches or determines that the PS signal meets the PRI value range (or a banded value +/−about the PRI), the controller activates the first subset light group: all ON; flashing ON; or progressively sequentially ON.

Another embodiment of the invention uses a proximity element-reader system (a RFID tag—RFID reader or a NFC tag—NFC reader) and the controller and memory have a low pressure range determinator which generates progressive light control signals when the PS signal is within a detected low pressure range. The controller and memory also have an over-pressure determinator which generates over-pressure light control signals when the PS signal is detected above the PRI value. This embodiment has the 3+ light system. A first subset light group of the 3+ lights represents, when lit, a positive visual user feedback, indicating that the PS is within the banded range of the PRI. The controller activates a second subset light group of the 3+ lights with progressive light control signals when the PS signal is below a detected low pressure range. The controller activates a third subset light group of the 3+ lights in the presence of an over-pressure light control signals.

Other embodiments of the invention include an audio alarm disposed or located in or on the SFU. The audio alarm is coupled to the controller and the battery. The controller audibly announces a SFU condition via the audio alarm upon one or more of (i) the PX proximity signal bein sensed by the reader near the PX element, (ii) progressive light control signals, (iii) the over-pressure light control signals; or (iv) a match of the predetermined PRI value with the Ps signal.

In accordance with another feature, an embodiment of the present invention includes the SFU having one or more inflatable wings disposed on an exterior of the SFU. The inflatable wing carries one or more of the 3+ lights. A controllable valve is on the pneumatic passage. This valve is coupled to and controlled by the controller. When the controller opens the valve, the wing is inflated. The inflatable wing in inflated based upon a predetermined condition of the SFU detected by the controller and based upon a SFU condition state stored in the memory. The SFU condition state being one of (a) a pneumatic condition in the pneumatic passage, (b) a low pressure condition, (c) a high pressure condition, and (d) a KE module condition. The 3+ light system, triggered by the controller and the memory, represents a SFU conditional state, which lights, (a) positive visual user feedbacks, and (b) a second subset of the 3+ lights represents, when lit, negative visual user feedbacks, and (c) with a match of PRI and PS, the first subset light group of the 3+ lights may be: all ON, flashing ON, or progressively sequentially ON.

Although the invention is illustrated and described herein as embodied in the tire pressure inflation sensor and control system with visual user feedback, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

In the description of the embodiments of the present invention, unless otherwise specified positional relationships indicated by terms such as “left,” “right,” “inside,” “outside,” “front,” “back,” and so on, are positional relationships based on the drawings, which are only to facilitate description of the embodiments of the present invention and simplify the description, but not to indicate or imply that the devices or components must have a specific azimuth, or be constructed or operated in the specific azimuth, which thus cannot be understood as a limitation to the embodiments of the present invention. Furthermore, terms such as “first,” “second,” “third,” and so on are only used for descriptive purposes and cannot be construed as indicating or implying relative importance.

In the description of the embodiments of the present invention, it should be noted that, unless otherwise clearly defined and limited, terms such as “installed,” “coupled,” “connected” should be broadly interpreted, for example, it may be fixedly connected, or may be detachably connected, or integrally connected; it may be mechanically connected, or may be electrically connected; it may be directly connected, or may be indirectly connected via an intermediate medium. As used herein, the terms “about” or “approximately” or “near” apply to all numeric values, whether or not explicitly indicated. These terms generally refer to a range of numbers that one of skill in the art would consider equivalent to the recited values (i.e., having the same function or result). In many instances, these terms may include numbers that are rounded to the nearest significant figure. In this document, the term “longitudinal” should be understood to mean in a direction corresponding to an elongated direction of the central axis of the SFU running from tire stem 44 to pneumatic coupler stem 46. The terms “program,” “software application,” “App,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequences of instructions designed for execution on a computer system. Those skilled in the art can understand the specific meanings of the above-mentioned terms in the embodiments of the present invention according to the specific circumstances.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

### BRIEF DESCRIPTION OF THE DRAWINNGS

In the accompanying Figures, like reference numerals refer to identical or functionally similar elements throughout the separate views. Together, these drawings, with the detailed description below, are incorporated in and form part of the specification. The drawings and the detailed description serve to further illustrate various embodiments and explain various principles and advantages all in accordance with the present invention.

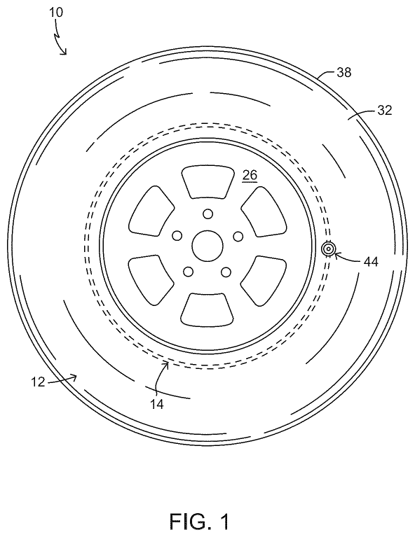

FIG. 1 diagrammatically illustrates a vehicle tire mounted on a tire rim wherein the tire is inflated by and through an integrated valve-tire stem (sometimes referred to herein as the “tire stem”).

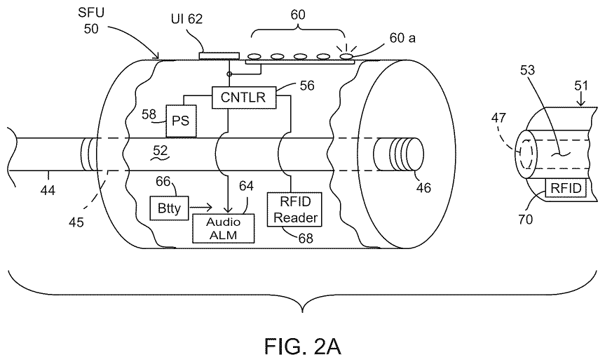

FIG. 2A diagrammatically illustrates one embodiment of the tire pressure inflation sensor and control system with visual user feedback and audible feedback (a Sensory Feedback Unit, SFU 50 with AV feedback subsystems) adapted to connected, at one end, to the tire stem and, at the other end, to the pump station supply line hose (a tire pressure hose) supplying tire inflating air flow to the tire.

FIG. 2B diagrammatically illustrates another embodiment of the tire pressure inflation sensor and control system with AV feedback incorporating a supply line proximity reader.

FIG. 2C diagrammatically illustrates multiple electronic components coupled to one or more complementary signal conditioners and the SFU controller having an onboard memory.

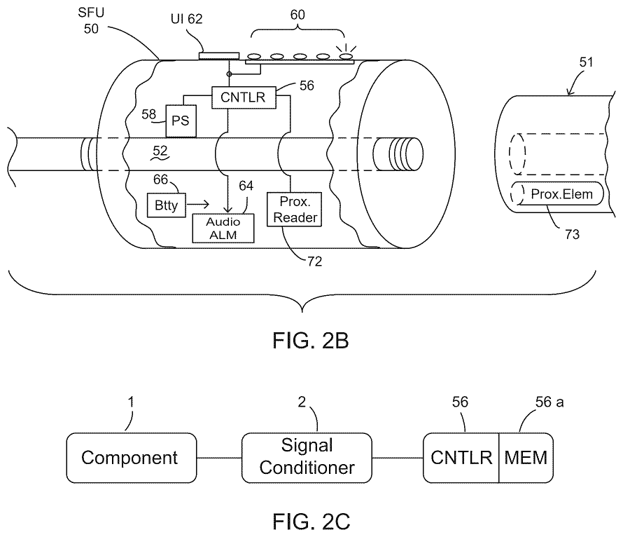

FIG. 3A diagrammatically illustrates a further embodiment of the tire pressure inflation sensor and control system powered in whole or in part by an electrical power supply line on or embedded within the tire pressure hose.

FIG. 3B diagrammatically illustrates the SFU enabled to the electrically coupled to a recharger or a recharging dock.

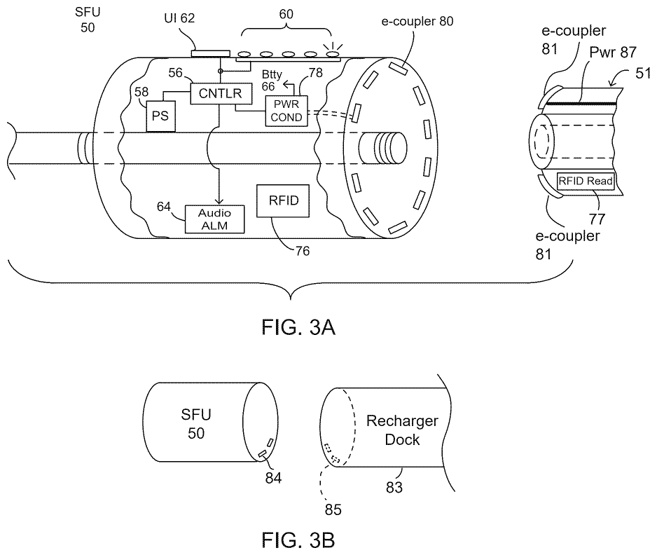

FIG. 4 diagrammatically illustrates another embodiment of the tire pressure inflation sensor and control system incorporating a kinetic energy converter (a KE generator).

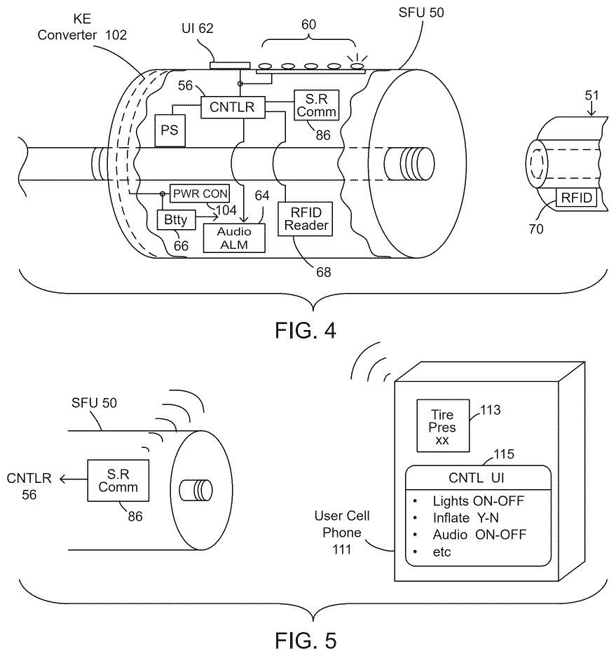

FIG. 5 diagrammatically illustrates another embodiment of the SFU which is controlled in part by a cell phone.

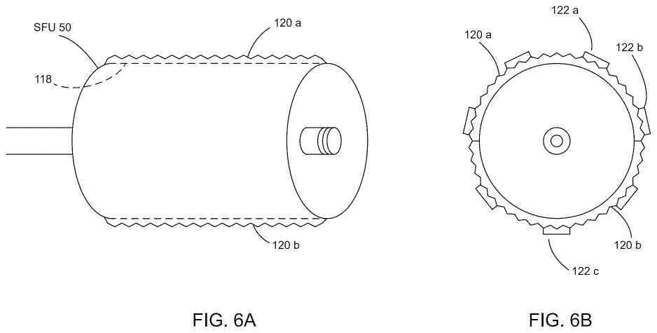

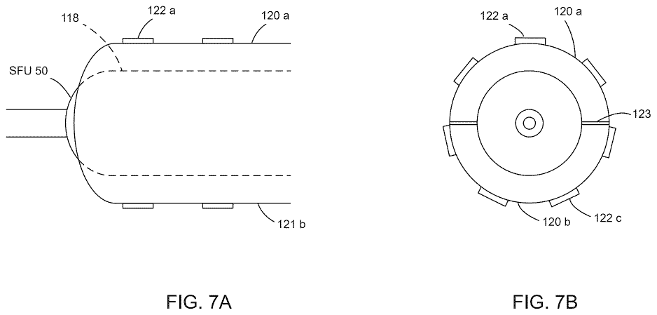

FIGS. 6A, 6B, 7A, and 7B diagrammatically illustrate further embodiments of the SFU which include pneumatically activated wings in an inflated mode and a deflated mode.

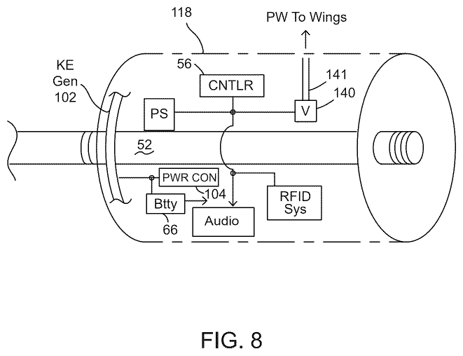

FIG. 8 diagrammatically illustrates internal operative components for the inflatable wings carried by the SFU.

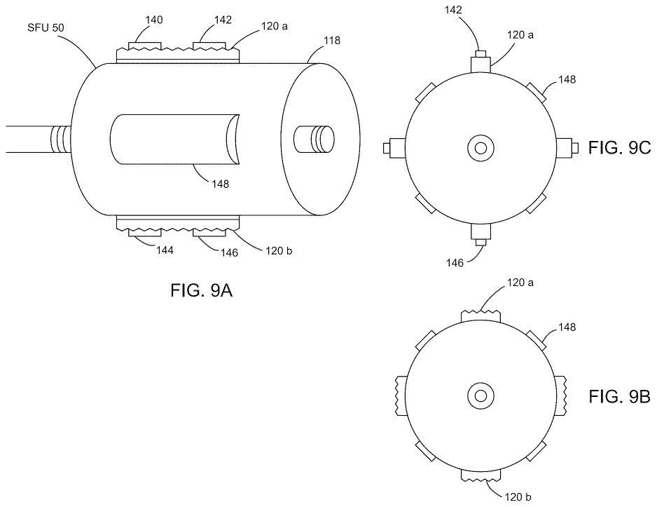

FIGS. 9A, 9B and 9C diagrammatically illustrate the tire pressure inflation sensor and control system with inflatable wings arcuately spaces apart on the exterior of the SFU body (FIG. 9B shows arcuately spaced apart wings in a deflated mode and FIG. 9C diagrammatically illustrates the arcuately spaced apart wings in an inflated mode).

### DEATAILED DESCRIPTION

The present invention relates to a tire pressure inflation sensor and control system with visual user feedback and audible feedback subsystems. While the specification concludes with claims defining the features of the invention that are regarded as novel, it is believed that the invention will be better understood from a consideration of the following description in conjunction with the drawings, in which like reference numerals refer to similar items. It is to be understood that the disclosed embodiments are merely exemplary of the invention, which can be embodied in various forms.

Referring to FIG. 1, tire assembly 10 includes a tire 12, and a tire rim 14 (shown in dashed lines) with an annular rim body 28. The tire 12 mounts in a conventional fashion to a pair of rim mounting surfaces located adjacent the outer rim flanges of rim body 28. The tire includes a conventional pair of sidewalls 32 extending from rim body 28 to a crown or tire tread region 38. The tire and rim enclose an interior tire cavity 40. A conventional tire stem 44, which includes a built-in valve, is pneumatically coupled to tire cavity 40.

FIG. 2A diagrammatically illustrates one embodiment of the tire pressure inflation sensor and control system with visual user feedback and/or audible feedback adapted to be connected to a tire pressure hose. Sensory feedback unit, SFU 50 includes, in this embodiment, a complementary pneumatic coupler port 45 at one end of the SFU and, at the second end, a complementary pneumatic port 46 at the other and of the SFU. Both pneumatic ports 45, 46 have built-in pneumatic valves such that when port 46 is coupled to pneumatic port 47 of tire pressure hose 51, inflatable air under pressure is transferred from hose air channel 53 into pneumatic passage 52 of the SFU 50. In operational, when pneumatic port 45 attached to tire stem 44, the interior valve in tire stem 44 is opened thereby permitting the air flow under pressure to be applied and supplied to the interior chamber of tire 10 through SFU passage 52 because the air under pressure is supplied to passage 52 via port 46 (also having an interior valve) and port 47 of tire pressure hose 51. Port 47 also have an internal air valve actuate OPEN when ports 46 and 47 are coupled or connected together.

SFU 50 includes a pressure sensor PS 58 that is pneumatically accessible to passage 52. Pressure sensor PS 58 is coupled to controller 56. Controller 56 may be a microcontroller. In the illustrated by element, controller 56 is electrically coupled to RFID reader 68 and to audio alarm 64. Onboard battery 66 supplies power to all necessary electronic complements. Controller 56 is also connected to user interface UI 62 and a plurality of lights, one of which is light 60 and another light 60a is shown as being illuminated ON in FIG. 2A. Pressure hose 51 includes and RFID chip 70 which acts as a proximity element. RFID chip 70 is disposed in the terminal end of air pressure supply hose 51.

FIG. 2B diagrammatically illustrates another embodiment of the tire pressure inflation sensor and control system incorporating a proximity reader. The types of proximity readers are discussed below. Similar identify similar items throughout the drawings. FIG. 2B utilizes a proximity sensor 72 which is activated when proximity element 73 on or embedded in the air supply hose 51 is relatively SFU 50. The RFID system can be replaced with NFC readers and repeater-sensors (Near Field Communication modules, readers and sensory elements).

FIG. 2C diagrammatically illustrates an electronic component coupled to a complementary signal conditioner wherein the output of the signal conditioner is applied to controller (a microprocessor controller) which has an onboard memory. Component 1 represents any number of electronic components in the SFU 50 system. For example, a pressure sensor 58 (represented by component 1 in FIG. 2C) may generate a certain type of signal representative of the pressure PS in pneumatic passage 52. Pressure sensor 58 has an output PS which may be altered or made compatible with conditioner 2 to enable compatibility with controller 56. The sensory PS signal from sensor 58 may need to be conditioned, modified, amplified or otherwise altered to be compatible to the controller and other components. In a similar manner, proximity reader 72 (represented by component 1 in FIG. 2C) may have a different signal conditioner 2 in order to be operationally compatible with controller 56. Sometimes, the signal conditioner 2 is built into the component sensor 58, UI 62, lights 60, 62, audio alarm 64, RFID reader 68, and proximity reader 72. KE generator 102 in FIG. 4 may need a signal conditioner or power converter 104. Additionally, FIG. 2C shows that controller 56 is closely associated with memory 56a. That memory may be separate on an PC board or on the computer chip with controller 56. In other words, and in any event, memory 56a is electronically communicatively coupled with controller 56 and may be considered to be an onboard memory associated with controller 56.

FIG. 3A diagrammatically illustrates another embodiment of the tire pressure inflation sensor and feedback control system powered in whole or in part by an electrical power supply line 87 on or embedded in the tire pressure hose 51. FIG. 3A generally shows that the SFU 50 includes external end surface electrical couplers 80 which coact with the electrical end couplers 81 on tire inflation hose line 51. Couplers 80 and 81 come in contact with each other when a pneumatic coupling is made between the male pneumatic valve stem 46 (FIG. 2A) and the female pneumatic valve element 47 (FIG. 2A), both of which are diagrammatically illustrated in FIG. 3A. E-coupler 81, coacts with e-coupler 80 to transfer electrical power from electric power line 87 which is carried by tire pressure hose 51. Operationally, the coupler elements 80 of SFU 50 coacts with e-couplers 81 at the terminal end of inflation pressure hose 51 such that couplers 81 matches and is electrically connected to couplers 80 of SFU 50. Although no battery is shown in FIG. 3A, SFU 50 may include an onboard battery. FIG. 3A also shows that power conditioner 78 diagrammatically transfers electrical power from e-couplers 80, 81 to battery 66.

FIG. 3B diagrammatically illustrates the SFU 50 can be enabled to be electrically coupled to a recharger dock to recharge battery 66 shown in FIGS. 2A and 2B. SFU 50 is shown as including e-couplers 84 which are complementary to e-couplers 85 on recharger dock 83.

FIG. 4 diagrammatically illustrates another embodiment of the tire pressure inflation sensor and feedback control system incorporating a kinetic energy converter, KE converter 102. Kinetic energy converter KE 102 is disposed inboard of SFU 50. KE converter 102 is electrically connected to a power converter 104 and also to battery 66. Power converter 104 may separately power the other electronics the other onboard electronics in SFU 50. FIG. 4 also diagrammatically shows a short-range SR communications module 86. SR communications module 86 is adapted to interact with the user's cell phone 111 shown in FIG. 5. SR communications include BLE or Bluetooth communications, NFC modules and others.

FIG. 5 diagrammatically illustrates another embodiment of the SFU 50 which is controlled in part by a cell phone 111 in FIG. 5A. SFU 50 includes short-range SR communications module 86 which is in communication with cell phone 111. Cell phone 111 has several displays, one of which, as an example, shows tire pressure value X in user interface (UI) 113, that is, display region 113. Cell phone 111 also has a user interface UI actuatable area, such as a touch screen 115. The user interface, UI, enables the user to provide command control signals to SFU 50 and to remotely view the internal tire pressure of tire 10 (FIG. 1). SFU 50 is configured to be generally continuously attached to tire stem 44 (FIG. 1), notwithstanding the fact that SFU 50 is removably attached to tire stem 44. As example, the cell phone actuatable user interface UI control 115 could return light system 60 by ON-OFF commands, could indicate that tire inflation is currently in process with a YES-NO indicator or a green or red visual indicator, and could enable the user to turn ON and OFF audio alarm 64. Other user actuatable UI controls could be provided to the user via his or her cell phone 111. Further, the UI display 113 may display to the user the then-current tire pressure during the inflation process when the pressure hose is attached to the SFU 50 and air is being transferred from the hose 52 through passage 52 into the tire 10.

FIGS. 6A, 6B, 7A, 7B, 9A, 9B and 9C diagrammatically illustrate a further embodiment of the SFU 50 which includes either pneumatically actuated wing (which also may be a full-circumferential expandable ballon, the term “wing” includes this 360 degree inflatable ballon structure as well as wings having arcuate spans as explained herein). FIGS. 6A, 6B, 9A and 9B diagrammatically illustrate the wings in a deflated mode and FIGS. 7A, 7B and 9C diagrammatically illustrate the wings in an inflated mode. FIG. 7B shows a small gap 123 between wing 120a and 120b. A full-circumferential expandable ballon or single wing would not have gap 123. The inflatable arcuate wings can span any arcuate space as selected by the designer. FIGS. 6A and 7B show large arcuate span arcuate wings 120 a, 120 b deflated (FIGS. 6A, 6B) and inflated (FIG. 7A. 7B). FIGS. 9A, 9B and 9C show small arcuate span wings 120a, 120b deflated (FIGS. 9A, 9B) and inflated (FIG. 9C). Operationally, the wings may provide an additional visual feedback signal or sign to the user. In an under-pressure condition (sometimes described as an under-pressure determination by the controller 56), wings may be deflated. Also, during a tire inflation cycle, controller 56 would turn OFF-CLOSE value 140.

In this group of Figures, inflatable wings 120a, 120b are disposed on exterior surface 118 of SFU 50 shown in dashed lines in FIG. 7A and shown in solid lines in FIG. 9A. FIG. 6B shows that large arc inflatable wing 120a (and wing 120b) has exteriorly mounted multiple lights 122a (see also lights 122c on wing 120b). In FIGS. 9A, 9B and 9C, lights 140, 142, 144, 146 are mounted on exterior surfaces of the wings 120a and 120b. FIGS. 9A, 9B and 9C show small arcuate inflatable wings 120a and 120b, each carrying exteriorly mounted lights 140, 142, 144, 146. Also, in FIGS. 9A and 9C, the arcuate space between each inflatable wing carries lights 148. Another feature of the invention is shown in FIG. 9A wherein the longitudinal span of a single light or multiple lights 140 is less than the longitudinal span of the wing and light or lights 140 is longitudinally spaced apart from another set of lights 142 (which may be singular lights). In other words, lights 122a and 122b are arcuately spaced apart on the peripheral surface of inflatable wings 120a, 120b. Wings 120a and 120b in FIGS. 9A and 9C also have one or more lights 140, 142, 144 and 146.

FIGS. 7A and 7B show that wings 120a, 120b have been inflated and as a result the exterior surface of these wings are pushed away from surface 118 of SFU 50. Lights 122a, 122c are on the outside surface of wings 120a, 120b. FIGS. 9A, 9B and 9C show that lights 148 are disposed on the exterior surface 118 of the FDC 50. Additionally, the wings 120a, 120b in FIG. 9C, when inflated, are arcuately spaced apart from the on-surface-SFU mounted lights 148. In FIG. 9A, wing lights 140, 142, 144, 146 are arcuately spaced apart from SFU onboard lights 148. Lights 122a, 122c, 140, 142, 144, 146 and 148 may be single lights mounted on the respective surfaces or be multiple lights mounted thereon.

FIGS. 9A, 9B and 9C diagrammatically illustrate the tire pressure inflation sensor and control system with inflatable wings arcuately spaced apart. These are discussed earlier hereinabove.

In connection with the embodiment in FIG. 2A, in one operational mode, the RFID tag 70 is read by RFID reader 68 on the SFU 50 when the terminal end of pressure supply hose 50 is coupled onto or otherwise closely adjacent to SFU 50. As explained earlier, pneumatic coupler 46 on SFU 50 is complementary to and attachable to pneumatic port 46 of supply inflation hose 51. At the other end of SFU 50, pneumatic coupler port 45 is detachably and pneumatically coupled to tire stem 44. The current embodiment suggests that SFU 50 be mounted and kept on tire stem 44 (FIG. 1). The SFU would be removed to replace battery 66 (FIG. 2A) or recharge the battery (FIG. 3B) as needed. A recharge NOW condition could be visually indicated as feedback to the user by an ON, then long OFF (5 sec, for example) period, then ON again. If the KE generator 102 in FIG. 4 is used, a user-applied feedback signal or event can also trigger a recharge cycle for battery 66 in FIG. 4.

Operationally, during a tire inflation cycle, the SFU is attached to tire stem 44 (FIG. 1) and to the inflation supply hose 51. Stem 44 has an internal valve control which is OPEN when supply hose 51 is attached by port 47 to SFU tire stem valve 46. In one embodiment, when RFID reader 68 (FIG. 2A) senses the proximal presence of RFID tag 70 (on the supply hose), controller 56 in the SFU is activated ON by reader 68's output signal. Controller 56 turns ON pressure sensor 58 (if needed due to the electric nature of sensor 58). When the pressure line 53 carrying inflation air under pressure is applied to or supplied into SFU pneumatic passage 52, pressure sensor 58 in the SFU generates a signal PS which PS signal is sensed by controller 56. As shown in FIG. 2C, controller 56 operates with memory 56a.

The controller determines when pressure sensor signal PS matches a recommend tire inflation value PRI, that is, a predetermined PRI value which is stored in memory 56a (FIG. 2C) and generates an appropriate light control signal. Signal conditioner 2 (FIG. 2C) may convert this light control signal into an appropriate voltage or current to turn ON the designated light. Alternatively, the PRI could be initiated (generated) by the RFID chip activating the RFID reader 68 and which selects the correct PRI for the tire 10 from the stored into memory 56a. In the FIGS. 2A and 2B embodiments, the reader may be pre-programmed for the PRI of the vehicle (or the PRI of the tire) in one instance and the RFID chip may be pre-programmed with the PRI for the vehicle or the tire. Many tires inflate to the same PRI. In FIG. 3A, the RFID 76 in the SFU 50 could be replaced by the RFID reader 77 shown in the supply hose 51. FIG. 4 can be altered in a similar manner. The proximity reader 72 in FIG. 2B can be swapped from the SFU 50 and replaced with the proximity element 73 from supply hose 51. Different proximity systems are discussed later herein. FIG. 2B shows a more generic proximity reader 72 triggered by a proximal proximity element 73 on or in the air supply hose 51. Different proximity triggers and readers are discussed later.

In connection with the embodiment wherein the SFU 50 carries the user interface UI 62 (for example, FIGS. 2A, 2B), at an earlier initialization time (during an initialization period), the user activates the onboard UI 62 which may have certain characteristics discussed later enabling the user to enter the PRI for the specific tire 10 into memory 56a via UI 62 and controller 56. The PRI value is the recommended tire pressure. The controller, obtaining pressure signal PS from sensor 58, determines when the detected pressure PS in passage 52 matches the recommend entire inflation value PRI and, upon making that determination, controller 56 illuminates one or more of the lights 60 (see illuminated light 60a) I light group 60. UI 62 may be a series of user actuatable buttons or a small touch screen. For the button configuration, assuming 3 buttons, a UI initialization could be: (a) simultaneously press buttons “1” and “3” for 5 sec. ; (b) see lights 60 ALL flash ON; (c) enter the PRI by striking the button “2” THREE times for the tens place PRI and then strike button “1” TWICE for the ones place, resulting in setting the PRI to “32 psi.” Other manual keyed-in processes may be permitting the user to input PRI into the SFU.

If a small digital UI screen was used as part of UI 62, the PRI value may be shown on the screen as the user presses the buttons in a predetermined sequence. Also, lights 60 could be used to inform the user of the then-entered PRI. A 3-period FLASH ON sequence on light “2” followed by a 5 second OFF light AND a 2-period FLASH ON sequence on light “1” can indicate 32 psi for the stored PRI value. Other visual feedback systems may be used to inform the user of the entered PRI value.

In the cellphone-controlled system (see generally, FIGS. 4 and 5), the SFU could be initialized by the cellphone 111 via the SR communications module 86 wirelessly coupled to the SFU comm module 86. This would require a downloaded App into the phone 111 and a wireless interconnect communications channel between comm module 86 and phone 111. To initialized the SFU, the user activate an initialize program in the App, and is instructed via the cellphone screen to manually enter the PRI via the touch screen phone control and this PRI value is then stored into memory 56a of the SFU.

Another light control event (which is optional), determines when proximity element RFID chip 70 is near proximity RFID reader 68 (see FIGS. 2A, 2B and 3A for chip and reader conditions). Controller 56 senses proximity signal PX from reader 70 (or reader 68) and the controller can be configured to visually indicate and turn ON light array 60 to show (i) proximity signal PX; (ii) sense the then-acquired tire pressure in tire 10 BEFORE supply hose is pneumatically attached to the SFU, and (iii) present visual (or audio) feedback signals to the user for (a) the presence of high PS above the PRI and illuminating one subgroup of lights (maybe a single) of the plurality of lights 60); (b) the PS matching, within a predetermined banded range, the stored PRI and illuminating a second subgroup of lights (maybe ALL) of the plurality of lights 60; and (c) detecting a low PS pressure in passage 52 (an under-pressure determination) and illuminating a third subgroup of lights (maybe ALL FLASHING) of the plurality of lights 60. Different visual feedbacks may be provided to the user. Also, the visual feedback may be supplemented by the controller activating audio alarm 64 either separately or in combination with the lights. For example, detecting a low PS pressure in passage 52 and illuminating a fourth subgroup of lights (maybe sequential ON/OFF for light 1, then light 2, then 3, and finally light 4) of the plurality of lights 60 and triggering an audio ON/OFF announcement via controller 56 and alarm 64.

Other examples for a high PS may be FAST FLASH ON ALL LIGHTS, and a low PS may be a single ON light “1” in the light array 60, and, for a matching PS and PRI condition (or within a bounded PRI +/−2 psi range for the common 32 psi PRI), all lights FLASH sequentially ON then OFF, for example, light 1 ON, then OFF, light 2 ON then OFF, et. seq. Other visual user feedback signals can be pre-programmed into the controller 56.

The several different pressure conditions in pneumatic passage 52 trigger visual and possibly audio feedback announcements to the user by (a) flashing lights, (b) sequential flashing lights (for example, during a tire inflation event (when high pressure air is fed into tire 10)), (c) a single ON light (for example indicating the PX proximity signal), (d) all ON (indicating a PS and PRI match), (e) a different single ON light for low pressure below the PRI (this single warning alarm light may be independent of whether the proximity PX signal is active, thereby informing the user that the subject tire pressure is below PRI). Hence, the SFU 50 may be coupled to tire stem 44 at all times, thereby indicating the pneumatic condition of tire pressure in tire 10 during the “SFU connected” time period. In this control sequence, the lights 60 are OFF unless a low pressure (less than PRI or a banded pressure below PRI) is detected by controller 56 monitoring sensor 58 and the PS signal.

In this configuration, the SFU pneumatic coupler 46 is generally a closed OFF integrated tire stem valve which only opens ON when the complementary supply coupler 47 is placed on SFU coupler 46. In a similar manner, SFU coupler 45 is designed to activate OPEN when coupler 45 is on the tire stem valve 44. Hence, when proximity element RFID 70 is NOT detected by proximity RFID reader 68, that is, there is no proximity signal PX sensed by controller 56, and, when SFU unit 50 is pneumatically attached to the tire stem 44, the pressure PS in passage 52 equals the pressure in tire 10. In this situation, there is a possibility that the pressure in SFU passage 52 as well as tire 10 does not meet or exceed the recommended, banded tire pressure PRI value (a NO match condition to the PRI pressure band stored in memory 56a). In that situation, controller 56 would activate a second group of lights in light array 60 indicating to the user that there is a low pressure differential in the internal pressure of the tire 10. As explained above, the first group of lights, or a single light, is illuminated then the PX signal in ON and the sensed pressure PS matches the stored PRI value.

In a further control embodiment, a negative visual user alarm is activated by a third light illumination display indicating, for example, an overpressure condition during inflation, when the PX signal in ON and, during an inflation event the sensed pressure PS exceeds the banded PRI pressure stored in memory 56a (“banded” referring to the, for example, +/−2 psi for a common 32 psi PRI). The controller makes an over-pressure determination. For example, if the pressure in tire 10 is higher than the recommended banded PRI pressure, an overpressure determination is made by controller 56 as measured by a higher PS value than the PRI band value stored in memory 56a. This overpressure condition activates a function in the controller 56 to illuminate a third group of lights in light array 60. The overpressure visual alarm may cause a certain sequence of lights to be illuminated. If the pressure in the tire is below the PRI band value, an under-pressure light control signal is generated by controller 60 which generates a difference combination of lights to be illuminated. Stated otherwise, in a light system 60 which has at least three or more lights, herein generally referred to as “3+ lights.” A first subset of the 3+ light group represents the positive visual user feedback indicating that pressure in pneumatic passage 52 equals recommended pressure PRI inside the tire, as recommended by the tire manufacturer or the vehicle manufacturer. When the pressure in passage 52 is below the PRI band, a second subset of the 3+ lights are illuminated. If the pressure PS is above the PRI pressure band (on overpressure condition), a third subgroup of the 3+ lights is illuminated. Light 60a is shown illuminated in FIG. 2A.

The inflatable wing or wings in FIGS. 6A, 6B, 7A, 7B, 9A, 9B and 9C each carry one or more of the 3+ lights. The valve 140 is coupled to and controlled by the controller. When the controller 56 opens the valve 140, the wing is inflated. Different wings may be inflated or deflated by other valves open to passage 52. The wings always have less pressure than the PS in passage 52, thereby permitting deflation and re-inflation by the controller. The inflatable wing may be inflated based upon a predetermined condition of the SFU detected by the controller and presets or preprogrammed conditions in the memory 56a. These are SFU condition states stored in the memory. These SFU condition states are one of (a) a pneumatic condition state in the pneumatic passage, (b) a low pressure condition state, (c) a high pressure condition state, and (d) a KE module condition state. The KE state may INFLATE the wing when a certain rotation per minute is sensed by the KE generator, then causing the wings or wing to inflate.

The user interface 62 may be a touch screen or button control which is initially activated ON by a certain depression of one or more touch screen regions or button depression sequence. In a simple initialization operation, the user depresses the initial activation ON control by way of UI 62. Initialization routines are discussed above.

The pressure sensor 58 may be one of several types. Pressure sensors PS can be broadly categorized by the type of pressure they measure (absolute, gauge, differential) and their sensing mechanism (capacitive, piezoelectric, strain gauge, etc.). Common types include absolute pressure sensors, gauge pressure sensors, differential pressure sensors, vacuum pressure sensors, and strain gauge pressure sensors. Absolute Pressure Sensors: Measure pressure relative to a perfect vacuum (zero absolute pressure). Gauge Pressure Sensors: Measure pressure relative to atmospheric pressure (the pressure at sea level). Differential Pressure Sensors: Measure the difference between two pressures. Vacuum Pressure Sensors: Used to measure pressures below atmospheric levels. Strain Gauge Pressure Sensors: Utilize the principle that the resistance of a material changes under stress, allowing for pressure measurement. Piezoelectric Pressure Sensors: Generate an electrical charge when subjected to pressure. Capacitive Pressure Sensors: Measure pressure by detecting changes in capacitance. Optical Pressure Sensors: Use light to measure pressure, often offering high accuracy. Piezoresistive Pressure Sensors: Utilize the change in resistance of a material under pressure to measure pressure. Resonant Pressure Sensors: Measure pressure based on the resonant frequency of a vibrating diaphragm. Potentiometric Pressure Sensors: Use changes in resistance within a potentiometer to measure pressure.

Also, there are several proximity sensors and sensory systems. Radar sensors emit radio waves and listen for echoes. It detects motion and measures the distance, speed, and direction of objects. Magnetic sensors (Reed or Hall effect): detect a magnetic field. When a permanent magnet moves within range, a switch is activated. Inductive proximity sensors emit an electromagnetic field. A metal object entering the field creates eddy currents that reduce the field's strength, triggering the sensor. These sensors have a short range. RFID sensory systems operate inductively. Capacitive proximity sensors emits an electrostatic field. An object entering the field changes the sensor's capacitance, triggering the sensor. The detection range is affected by the size and composition of the target. Passive Infrared (PIR) sensors with IR Reflectors detect changes in the amount of infrared (IR) radiation, or heat, in its field of view (direct line of sight). Photoelectric sensors operating with Light Reflectors emit a light beam (often infrared) from an emitter to a receiver. Electronic sensors that replace RFID systems for item identification and tracking include NFC (Near Field Communication) devices which are short-range, contactless technology that uses RF communication to exchange data between two devices. Smart phones use BLE (Bluetooth Low Energy) which are short-range wireless technologies.

Kinetic energy converters operable on rotating vehicle wheels are known. Lighted hubcaps, also known as LED wheel lights, are powered by the rotation of the tires through a system of energy harvesting. Kinetic energy KE conversion generally works in the following manner. As the wheel spins, a generator inside the hubcap uses the rotational energy to produce electricity. This generated electricity is then stored in a power storage module, such as a battery or capacitor. A power converter adjusts the stored energy to power the LEDs mounted on the hubcaps.

The claims appended hereto are meant to cover modifications and changes within the scope of the invention.

What is claimed is:

1. A tire pressure inflation sensor and control system with a visual user feedback adapted to be actuated by a proximity element at a terminal end of a tire pressure hose, the tire pressure hose adapted to deliver inflation air under pressure to a vehicle tire via a hose stem pneumatic coupler at the terminal end of the tire pressure hose when the hose stem pneumatic coupler is attached to a vehicle tire stem of the vehicle tire, the tire pressure inflation sensor and control system comprising:
a sensory and feedback unit (SFU) adapted to be removably attached intermediate the vehicle tire stem and the hose stem pneumatic coupler, the SFU having a first pneumatic coupler adapted to be removably attached to the vehicle tire stem and a second pneumatic coupler adapted to be removably attached to the hose stem pneumatic coupler, and the SFU having a pneumatic passage through the SFU pneumatically interconnecting the first and second pneumatic couplers;
a proximity reader in the SFU which generates a proximity signal (Px) when the reader is within range of the proximity element of the tire pressure hose;
a pressure sensor at the pneumatic passage which generates an inflation air pressure signal (Ps) when the first pneumatic coupler is attached to the vehicle tire stem and the second pneumatic coupler is attached to the hose stem pneumatic coupler;
a plurality of lights on the SFU enabled to provide the visual user feedback;
a controller coupled to the pressure sensor and receiving the Ps signal and coupled to the proximity reader and receiving the Px signal, the controller having a memory storing a predetermined recommended tire inflation (PRI) value for the vehicle tire, and when the controller matches the predetermined PRI value with the Ps signal, the controller enables illumination of at least one light of the plurality of lights as a positive visual user feedback.

2. The tire pressure inflation sensor and control system as claimed in claim 1 including a user actuatable (UI) interface coupled to the controller, the UI interface disposed on an exterior surface of the SFU wherein a user is enabled to enter in the PRI value for the vehicle tire such that the PRI value is stored in the memory; and wherein when the controller does not match the predetermined PRI value with the Ps signal, the controller enables illumination of at least a second light of the plurality of lights as a negative visual user feedback.

3. The tire pressure inflation sensor and control system as claimed in claim 2 including a battery disposed in the SFU, the battery coupled to and powering the controller, the pressure sensor and the proximity reader, and wherein the controller determine the match when the proximity reader generates the Px signal.

4. The tire pressure inflation sensor and control system as claimed in claim 3 wherein the battery is a rechargeable battery recharged by at least one recharging power source of the plurality of power sources including:
an onboard kinetic energy conversion (KE) module which KE module is disposed in the SFU;
an interconnected power line from a powered tire pressure hose wherein the powered tire pressure hose includes an electrical power supply line, wherein the rechargeable battery is enabled to be removably coupled to the interconnected power line by an SFU e-coupler port and a hose e-coupler port; or
a recharge power line from an external recharging station wherein the recharging station includes a recharging supply line, wherein the rechargeable battery is enabled to be removably coupled to the recharging power line by a SFU recharge-coupler port and a recharging station-coupler port.

5. The tire pressure inflation sensor and control system as claimed in claim 1 wherein the proximity element and the proximity reader is either:
a RFID tag and a RFID reader; or
a near field communication (NFC) tag and a NFC reader.

6. The tire pressure inflation sensor and control system as claimed in claim 4 wherein the proximity element and the proximity reader is either a RFID tag and a RFID reader or a near field communication (NFC) tag and a NFC reader;
the plurality of lights includes three or more lights (3+ lights);
wherein the at least one light of the plurality of lights is a first subset light group of the 3+ lights which represents, when lit, the positive visual user feedback, and wherein the at least second light of the plurality of lights is a second subset light group of the 3+lights which represents, when lit, the negative visual user feedback; and
wherein, when the controller matches the predetermined PRI value with the Ps signal, the controller activates the first subset light group: all ON; flashing ON; or progressively sequentially ON.

7. The tire pressure inflation sensor and control system as claimed in claim 4 wherein the proximity element and the proximity reader is either a RFID tag and a RFID reader or a near field communication (NFC) tag and a NFC reader;
wherein the controller and memory have a low pressure range determinator which generates progressive light control signals when the Ps signal is within a detected low pressure range, the low pressure range being less than the PRI value;
wherein the controller and memory have an over-pressure determinator which generates over-pressure light control signals when the Ps signal is detected above the PRI value;
wherein the plurality of lights is three or more lights (3+ lights);
wherein the at least one light of the plurality of lights is a first subset light group of the 3+ lights which represents, when lit, the positive visual user feedback;
wherein a second subset light group of the 3+ lights is lit by the controller with the progressive light control signals when the Ps signal is within the detected low pressure range; and wherein a third subset light group of the 3+ lights is lit by the controller by the over-pressure light control signals.

8. The tire pressure inflation sensor and control system as claimed in claim 7 including an audio alarm disposed in the SFU, the audio alarm coupled to the controller and the battery, the controller announcing a SFU condition via the audio alarm upon at least one of (i) the Px signal, (ii) progressive light control signals, (iii) the over-pressure light control signals; or (iv) match of the predetermined PRI value with the Ps signal.

9. The tire pressure inflation sensor and control system as claimed in claim 4:
wherein the plurality of lights is three or more lights (3+ lights);
the SFU including an inflatable wing disposed on an exterior of the SFU, the inflatable wing carrying one or more of the 3+ lights;
a controllable valve on the pneumatic passage, the valve coupled to and controlled by the controller such that the controller opens the valve and inflates the one inflatable wing based upon a predetermined condition of the SFU detected by the controller based upon a SFU condition state stored in the memory, the SFU condition state being one of a pneumatic condition in the pneumatic passage, a low pressure condition, a high pressure condition, or a KE module condition;
wherein the proximity element and the proximity reader is either a RFID tag and a RFID reader or a near field communication (NFC) tag and a NFC reader;
wherein the at least one light of the plurality of lights is a first subset light group of the 3+ lights which represents, when lit, the positive visual user feedback, and wherein the at least second light of the plurality of lights is a second subset light group of the 3+ lights which represents, when lit, the negative visual user feedback; and
wherein, under the control of the controller and memory with the match of the predetermined PRI value with the Ps signal, the first subset light group may be: all ON, flashing ON, or progressively sequentially ON.
